(19) United States
(12) Patent Application Publication
(10) Pub. No.: US 2022/0277273 A1
(43) Pub. Date: Sep. 1, 2022

(54) COMMERCIAL ROADSIDE REPAIR AND RAPID DELIVERY STAFFING DISPATCH SYSTEM

(71) Applicant: Stanley Aron Cavienss, Atlanta, GA (US)

(72) Inventor: Stanley Aron Cavienss, Atlanta, GA (US)

(21) Appl. No.: 17/643,271

(22) Filed: Dec. 8, 2021

Related U.S. Application Data
(60) Provisional application No. 63/089,141, filed on Oct. 8, 2020.

(51) Int. Cl. G06Q 10/00; G06Q 10/06; G06Q 10/08; G06Q 30/08; G06Q 30/04; G06Q 20/10; H04W 4/40

(52) U.S. Cl. CPC G06Q 10/20; G06Q 10/06315; G06Q 10/063112; G06Q 10/0875; G06Q 10/0833; G06Q 10/0834; G06Q 30/08; G06Q 30/04; G06Q 20/102; H04W 4/40

(57) ABSTRACT

A commercial roadside repair and rapid delivery staffing dispatch system includes a server, a wireless communications network, a global positioning system, a service application and a client application. A service request with a photograph of repairs to be completed is used to calculate a cost. A time-limited bid is sent to local service personnel. The system tracks parts and labor time, generates an itemized invoice including any inspection fee and taxes which is sent to the client, and pays the service personnel. The system includes a database of repair costs. The applications have graphics showing the truck repair location and the service personnel location. The service application accepts the service bid and documents labor time and parts used. The client application transmits the service request and notifies the client when service bid has been accepted.

### CROSS-REFERENCE TO RELATED APPLICATION

This application claims the benefit of priority of U.S. provisional application No. 63/089,141, filed Oct. 8, 2020, the contents of which are herein incorporated by reference.

### BACKGROUND OF THE INVENTION

The present invention relates to staffing for commercial roadside repair and commercial rapid delivery and, more particularly, to a commercial roadside repair and rapid delivery staffing dispatch system.

The trucking industry has not advanced in technology. They use old systems for deliveries and repairs, making the customer, the mechanic, and the driver wait unnecessarily.

As can be seen, there is a need for a system that streamlines dispatch of diesel mechanics for roadside repair, dispatch of parts delivery drivers, and staffing of commercial drivers for short notice deliveries.

### SUMMARY OF THE INVENTION

Bring state of the art technology to the commercial truck industry.

In one aspect of the present invention, a computer-implemented commercial roadside repair and rapid delivery staffing dispatch system is provided, comprising: a wireless communications network and a global positioning system; a server in communication with the wireless communications network and the global positioning system, wherein the server is operative to receive a service request with a photograph of repairs to be completed, to calculate a cost to complete the service request, to transmit a time-limited service bid with a calculated remuneration amount, to identify local service personnel available, to track parts and labor time, to generate an itemized invoice including any combination of costs selected from the group consisting of: the parts, the labor time, an inspection fee, and taxes, to transmit the itemized invoice to a logistics client, to transfer payment from the logistics client to the service personnel upon completion of service, and to store data to and to retrieve data from a data storage device including repair costs; at least one service personnel computing device in communication with the server via the wireless communications network, wherein the service personnel computing device is operative to execute an application that establishes a time window of availability, provides graphics to see a location of a truck to be repaired, to transmit acceptance of the time-limited service bid to the server, and to document labor time and parts used; and at least one client computing device in communication with the server via the wireless communications network, operative to execute an application that transmits the service request with the photograph of repairs to be completed, that notifies the logistics client or commercial driver associated with the truck when the time-limited service bid has been accepted, and that provides graphics enabling the commercial driver to see a location of the service personnel.

In another aspect of the present invention, a commercial roadside repair and rapid delivery staffing dispatch method is provided, comprising; receiving, using one or more processors, a service request with a photograph of repairs to be completed; calculating, using one or more processors, a cost to complete the service request; generating, using one or more processors, a time-limited service bid with a calculated remuneration amount; identifying, using one or more processors, local service personnel available; transmitting, using one or more processors, the time-limited service bid to the service personnel; tracking, using one or more processors, parts and labor time incurred in servicing a truck; generating, using one or more processors, an itemized invoice including any combination of costs selected from the group consisting of: the parts, labor time, an inspection fee, and taxes; transmitting, using one or more processors, the itemized invoice to a logistics client; transferring, using one or more processors, payment from the logistics client to the service personnel upon completion of service; and storing, using one or more processors, data to and retrieving data from a database, including repair costs; generating, using one or more processors, graphics of a location of the truck and a location of the service personnel; and notifying, using one or more processors, the logistics client or commercial driver associated with the truck when the time-limited service bid has been accepted.

These and other features, aspects and advantages of the present invention will become better understood with reference to the following drawings, description, and claims.

### BRIEF DESCRIPTION OF THE DRAWINGS

FIG. 1 is a flow chart of a dispatch and tracking process according to an embodiment of the present invention;

FIG. 2 is a flow chart of a driver staffing process according to an embodiment of the present invention;

FIG. 3 is a home screen image of an application according to an embodiment of the present invention;

FIG. 4 is a map location image of an application according to an embodiment of the present invention;

FIG. 5 is a diagram of a driver staffing system according to an embodiment of the present invention; and

FIG. 6 is a diagram of a commercial road repair dispatch system according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a computer implemented staffing and urgent dispatch system for diesel mechanics performing commercial road service and for commercial driver's license (CDL) Drivers.

The inventive system links companies in need of roadside repair for commercial trucks and immediate Department of Transportation (DOT) stops with the nearest service trucks using one or more processors. For roadside repair, the commercial driver may submit a photograph of repairs needed with the repair request, enabling the mechanic to determine what repairs may be necessary. The inventive system calculates an estimated cost of repair and estimates a remuneration amount for the mechanic. The app may provide graphics enabling the driver to see the service personnel and truck in route. The trucks may be returned to service more quickly with effective and timely maintenance and daily repair of both tractor and trailer. Technicians may accept jobs nearest to them or identify a time that they are available for service of commercial break downs. A client trucking logistic company may see when road service is accepted. The present invention may enable a technician to complete well over 20 calls in day, making profitable use of time. The system documents all parts and labor time, enabling the technician to instantly invoice the client company for immediate payment.

In the event a technician needs a part to complete a repair, the technician may place a parts request and the inventive system enables rapid parts location and delivery to the mechanic at the work site picked up from a third party. With the inventive system, the mechanic may identify a part by photograph from a photographic parts inventory, ensuring that the correct part is delivered. A local available delivery driver may accept a delivery bid from the system. The parts delivery driver may be immediately paid after each delivery, i.e., on confirmation of delivery.

The inventive system also serves as a staffing service for commercial CDL drivers, with global positioning system (GPS) location features bringing truck drivers instant access to available loads. A logistics client may locate a qualified driver to drive a load for a quick shuttle or emergency recovery for freight. Drivers may accept jobs nearest to them or identify a time window that they are available for service. Upon completion of load delivery, the driver may get paid instantly. Moreover, the system tracks time and miles driven for the commercial driver, updating the driver's logbook and ensuring that drivers with sufficient remaining driving time and mileage capacity are selected for a particular load. The system provides the driver flexibility to work for any company and take any load that is paying more, taking loads anywhere and getting paid after each delivery, making him a prime contractor who can do more. Now companies can deliver more decades of Department of Transportation (DOT) time clock.

The inventive system may track invoice documentation numbers, the Global Positioning System (GPS) location of break downs and of drivers, and the time a service truck is en route. The system may include accounting software for instant point of service pay features and invoice receipts. Users may access the system using a cell phone with a wireless communication network or using any other suitable computing device. The system may provide service fee explanations and may add state and federal taxes to invoices and payments unless they are exempt.

The inventive staffing application may be operated via a website using HyperText Markup Language (HTML). A user may set up a password and a folder of criteria for diesel mechanics and CDL drivers. Candidates are screened for appropriate qualifications. Qualified candidates may login to the software and download an application for jobs. A second application enables logistic companies to establish a profile.

The inventive system may also be used for data inventory.

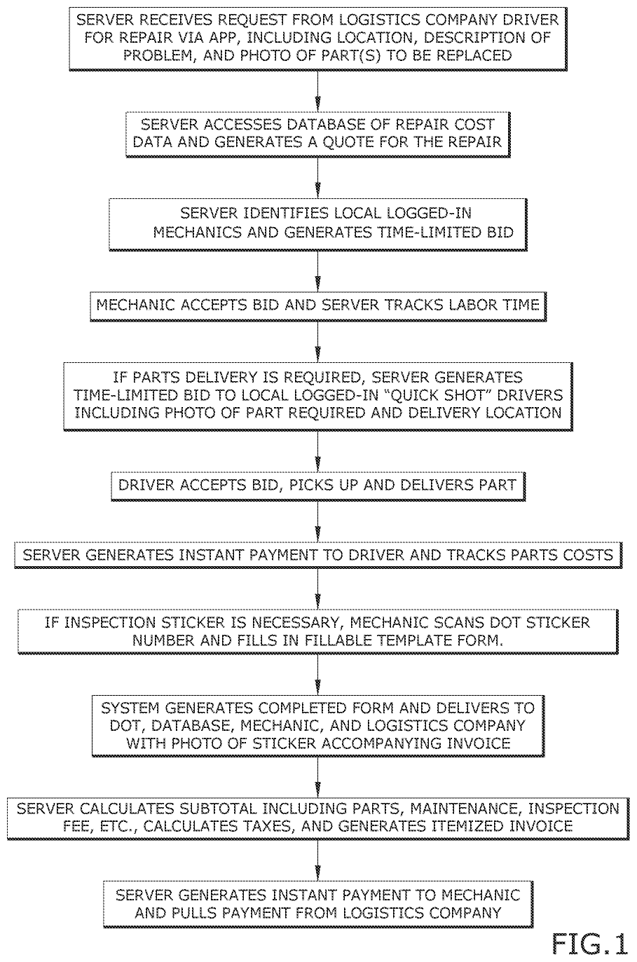

Referring to FIGS. 1 through 6, FIG. 1 provides a flow chart of a dispatch and tracking process according to an embodiment of the present invention. The server receives a request from a logistics company driver for repair via an app, including location, description of the problem, and a photo of part(s) to be replaced. The server accesses a data storage device of repair costs and generates a quote for the repair. The server also stores data on the database. The server identifies local logged-in mechanics and generates a time-limited service bid. A mechanic accepts the bid and the server tracks labor time. If a part needs to be delivered to the mechanic, the server generates a time-limited delivery bid to local logged-in “Quick Shot” drivers including a photo of the part required and the delivery location. A driver accepts the bid and picks up and delivers the part. The server generates instant payment to the driver, transferring payment from a predetermined account, and tracks costs, including parts. The server calculates a subtotal including but not limited to any combination of costs selected from the group consisting of parts, maintenance, inspection fee, etc., calculates taxes, and generates an itemized invoice. If the truck needs an inspection sticker, the mechanic scans a DOT sticker number and fills in a fillable form from a template, i.e., the app is operative to scan a sticker. The system generates the completed form, which is delivered to a government authority, e.g, the DOT, saved to a database, and sent to the mechanic and to the logistics company with the invoice and a photo of the sticker. The server generates instant payment to the mechanic and pulls payment from the logistics company.

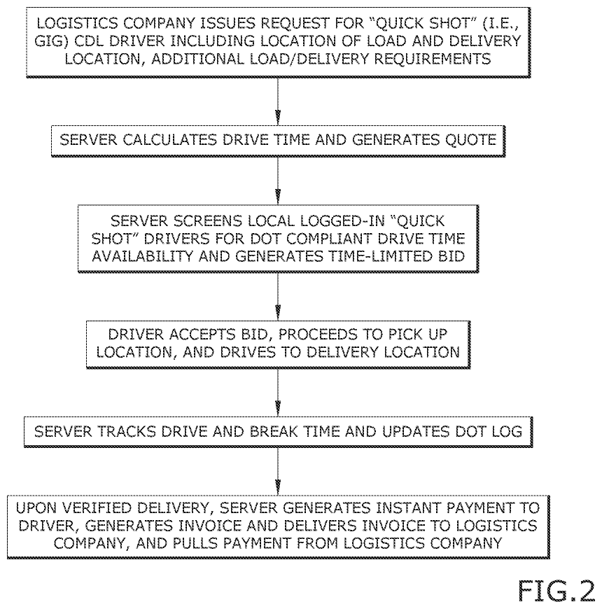

FIG. 2 provides a flow chart of a CDL staffing process according to an embodiment of the present invention. A logistics company issues a request for a “Quick Shot” (i.e., gig) CDL driver including the location of the load and the delivery location, and any additional load/delivery requirements. The server calculates the anticipated drive time and generates a quote. The server screens local logged-in “Quick Shot” drivers for DOT compliant drive time availability and generates a time-limited bid. A driver accepts the bid, proceeds to the pickup location and drives the load to the delivery location. The server tracks drive and break time and updates the driver's DOT log. Upon verified delivery, the server generates instant payment to the driver, generates and delivers an invoice to the logistics company, and pulls payment from logistics company.

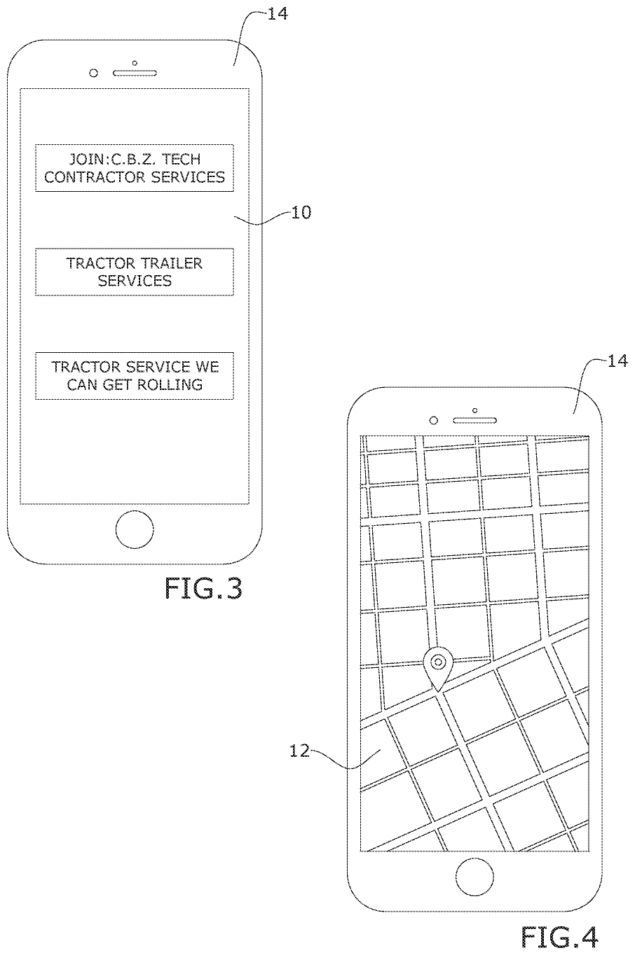

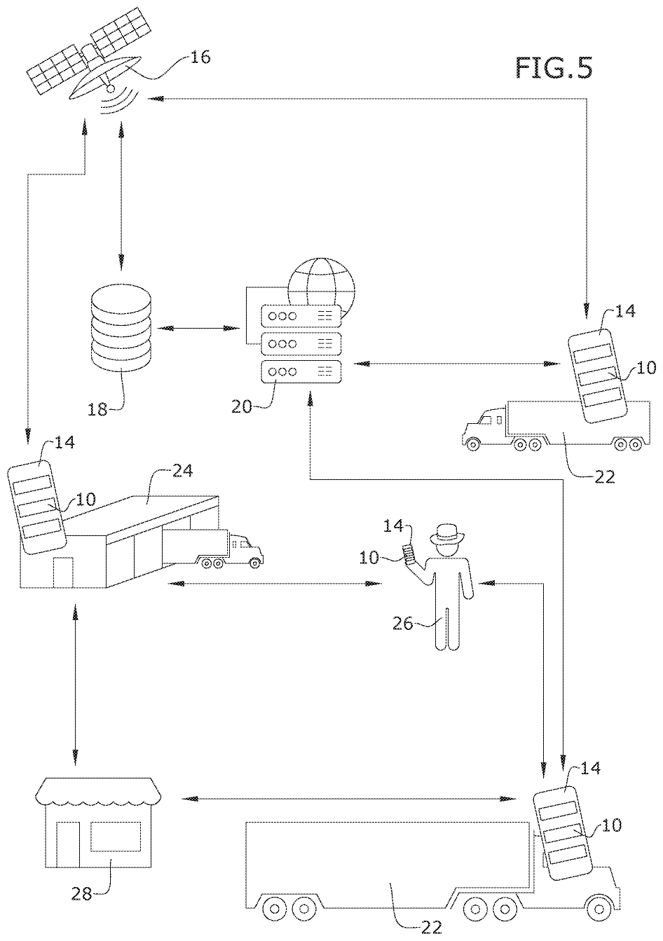

FIGS. 3 and 4 show images produced by an app according to an embodiment of the present invention, as seen on a user's phone 14, including an application home screen 10 in FIG. 3 and a service request location map screen 12 in FIG. 4.

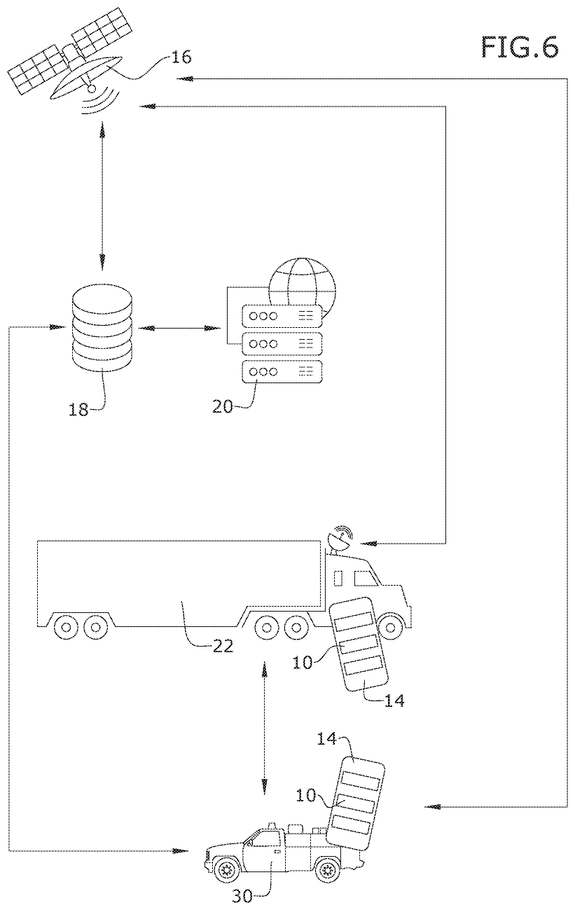

FIGS. 5 and 6 show system diagrams of the system according to embodiments of the present invention. As shown in FIG. 5, a satellite system 16 transmits signals between a data base 18 accessed by a server 20, a commercial truck driver's device, and a logistics company's device 14. The logistics company 24 communicates with a dispatcher 26 and a retail store 28, e.g., for delivery of a load. The commercial truck drivers 22 access the server 20 and one also access the retail store 28. In FIG. 6, a satellite system 16 transmits signals between a database 18 accessed by a server 20, a commercial truck driver 22, and a service truck 30. The service truck also accesses the commercial truck driver 22 and the database 18.

It should be understood, of course, that the foregoing relates to exemplary embodiments of the invention and that modifications may be made without departing from the spirit and scope of the invention as set forth in the following claims.

What is claimed is:

1. A computer-implemented commercial roadside repair and rapid delivery staffing dispatch system, comprising:
a wireless communications network and a global positioning system;
a server in communication with the wireless communications network and the global positioning system, wherein the server is operative to receive a service request with a photograph of repairs to be completed, to calculate a cost to complete the service request, to transmit a time-limited service bid with a calculated remuneration amount, to identify local service personnel available, to track parts and labor time, to generate an itemized invoice including any combination of costs selected from the group consisting of: the parts, the labor time, an inspection fee, and taxes, to transmit the itemized invoice to a logistics client, to transfer payment from the logistics client to the service personnel upon completion of service, and to store data to and to retrieve data from a data storage device including repair costs;
at least one service personnel computing device in communication with the server via the wireless communications network, wherein the service personnel computing device is operative to execute an application that establishes a time window of availability, provides graphics to see a location of a truck to be repaired, to transmit acceptance of the time-limited service bid to the server, and to document labor time and parts used; and
at least one client computing device in communication with the server via the wireless communications network, operative to execute an application that transmits the service request with the photograph of repairs to be completed, that notifies the logistics client or commercial driver associated with the truck when the time-limited service bid has been accepted, and that provides graphics enabling the commercial driver to see a location of the service personnel.

2. The computer-implemented commercial roadside repair and rapid delivery staffing dispatch system of claim 1, further comprising:
a parts delivery computing device in communication with the server via the wireless communications network, said parts delivery computing device being operative to execute an application that receives a time-limited delivery bid for pickup and delivery of a part and to transmit acceptance of the time-limited delivery bid to the server;
wherein the server further provides the service personnel with access to a photographic parts inventory stored on the data storage device, receives a parts request from the service personnel, transmits the time-limited delivery bid for pick up and delivery of the part to local available delivery drivers, receives a bid acceptance from one of the local available delivery drivers, tracks the delivery driver through delivery of the parts to the service personnel, and transfers payment to the local available delivery driver upon confirmation of delivery.

3. The computer-implemented commercial roadside repair and rapid delivery staffing dispatch system of claim 1,
wherein the service personnel computing device is operative to scan an inspection sticker, identify a Department of Transportation sticker number, to obtain a fillable form from the server, and to transmit the fillable form to the server upon completion by the service personnel;
and wherein the server is operative to generate a completed form from the fillable form, to save the completed form and a photograph of the inspection sticker to the data storage device, to transmit the completed form to a government authority, to transmit the completed form to the service personnel, and to transmit the completed form and photograph to the logistics client with the itemized invoice.

4. The computer-implemented commercial roadside repair and rapid delivery staffing dispatch system of claim 1, further comprising:
a commercial truck driver computing device in communication with the server via the wireless communications network, said commercial truck driver computing device being operative to execute an application that establishes a time window of availability, receives a time-limited delivery bid for load delivery from the logistics client, and transmits acceptance of the time-limited delivery bid to the server;
wherein the server further screens available commercial truck drivers for qualification for the time-limited delivery bid, transmits the time-limited delivery bid to qualified available commercial truck drivers, receives a bid acceptance from one of the qualified available commercial truck drivers, tracks driving time and mileage through pickup and delivery of the load, and transfers payment from the logistics client to the qualified available commercial truck driver upon confirmation of delivery.

5. The computer-implemented commercial roadside repair and rapid delivery staffing dispatch system of claim 4, wherein the server updates a logbook corresponding to the qualified available commercial truck driver.

6. A commercial roadside repair and rapid delivery staffing dispatch method, comprising;
receiving, using one or more processors, a service request with a photograph of repairs to be completed;
calculating, using one or more processors, a cost to complete the service request;
generating, using one or more processors, a time-limited service bid with a calculated remuneration amount;
identifying, using one or more processors, local service personnel available;
transmitting, using one or more processors, the time-limited service bid to the service personnel;
tracking, using one or more processors, parts and labor time incurred in servicing a truck;
generating, using one or more processors, an itemized invoice including any combination of costs selected from the group consisting of: the parts, labor time, an inspection fee, and taxes;
transmitting, using one or more processors, the itemized invoice to a logistics client;
transferring, using one or more processors, payment from the logistics client to the service personnel upon completion of service; and
storing, using one or more processors, data to and retrieving data from a database, including repair costs;
generating, using one or more processors, graphics of a location of the truck and a location of the service personnel; and
notifying, using one or more processors, the logistics client or commercial driver associated with the truck when the time-limited service bid has been accepted.

7. The commercial roadside repair and rapid delivery staffing dispatch method, of claim 6, further comprising:
retrieving, using one or more processors, a photographic parts inventory stored on the database;
receiving, using one or more processors, a parts request from the service personnel;
generating using one or more processors, a time-limited delivery bid for pickup and delivery of a part;
receiving, using one or more processors, a bid acceptance from a local available delivery driver;
tracking, using one or more processors, the local available delivery driver through delivery of the parts to the service personnel; and
transferring, using one or more processors, payment to the local available delivery driver upon confirmation of delivery.

8. The commercial roadside repair and rapid delivery staffing dispatch method, of claim 6, further comprising:
scanning, using one or more processors, an inspection sticker to identify a Department of Transportation sticker number;
generating, using one or more processors, a completed form from a fillable form;
saving the completed form and a photograph of the inspection sticker to a database; and
transmitting the completed form to a government authority, the service personnel, and the logistics client, wherein the completed form is transmitted to the logistics client with the photograph and the itemized invoice.

9. The commercial roadside repair and rapid delivery staffing dispatch method, of claim 6, further comprising:
screening, using one or more processors, available commercial truck drivers for qualification for a time-limited delivery bid,
transmitting, using one or more processors, the time-limited delivery bid to qualified available commercial truck drivers;
receiving, using one or more processors, a bid acceptance from one of the qualified available commercial truck drivers;
tracking, using one or more processors, the qualified available commercial truck driver driving time and mileage through pickup and delivery; and
transferring, using one or more processors, payment from the logistics client to the qualified available commercial truck driver upon confirmation of delivery.

10. The commercial roadside repair and rapid delivery staffing dispatch method, of claim 9, further comprising:
updating, using one or more processors, a logbook corresponding to the qualified available commercial truck driver.
